(19) United States
(12) Patent Application Publication
(10) Pub. No.: US 2023/0329302 A1
(43) Pub. Date: Oct. 19, 2023

(54) ALGINATE COMPOSITION FOR FOOD PRODUCTS, METHOD FOR ITS PRODUCTION AND PROCESS FOR PRODUCING COATED FOOD PRODUCTS

(71) Applicant: FREDDY HIRSCH GROUP AG, Hünenberg (CH)

(72) Inventors: Adushan Pillay, Cape Town (ZA); Johannes Gerhardus Maria Goorhuis, Amersfoort (NL)

(21) Appl. No.: 17/919,210

(22) PCT Filed: Feb. 23, 2021
(86) PCT No.: PCT/IB2021/051512

§ 371 Date: Oct. 14, 2022

(30) Foreign Application Priority Data
Apr. 22, 2020 (GB) 2005886.3

(51) Int. Cl. A23L 29/256; A23L 13/60; A23L 29/238; A23L 29/00; A23L 3/3517; A23P 30/25; A22C 13/00

(52) U.S. Cl. CPC A23L 29/256; A23L 13/65; A23L 29/238; A23L 29/035; A23L 3/3517; A23P 30/25; A23L 13/62; A22C 13/0016

(57) ABSTRACT

This invention relates to an alginate composition for coating food products, in particular fresh, skinless food products such as sausages, and a method for producing the alginate composition. Furthermore, the invention relates to a method for producing coated food products with the use of the alginate composition of the invention.

### FIELD OF THE INVENTION

This invention relates to an alginate composition for coating food products, in particular fresh sausages and a method for producing the alginate composition. Furthermore, the invention relates to a method for producing such coated food products with the use of the alginate composition of the invention.

### BACKGROUND OF THE INVENTION

Casings for food products, in particular fresh sausages (i.e. sausages that require cooking), are well known in the food industry, ranging from natural casings which are generally made from the sub-mucosa of the intestine of an animal comprised mainly of collagen, to a variety of artificial or synthesised casings. Synthesised or artificial casings may be comprised of any one or more of processed collagen, alginate salts, cellulose, or even plastic. Many collagen, cellulose and plastic casings are not edible and are required to be peeled from the meat product after cooking, producing for example, “skinless” sausages. This is a wasteful exercise which is also not particularly environmentally friendly. Casings comprising animal collagen may be edible, depending on the origin of the raw material, but carry the risk of prion disease such as bovine spongiform encephalopathy (BSE) or Creutzfeldt-Jakob disease as they are comprised from animal product. Furthermore, casings comprising collagen are not suitable for use in vegetarian or vegan products such as vegetarian or vegan sausages.

Casings comprised of the salts of alginic acid have been under development since at least the 60s. Alginate has been used as a film-forming element in co-extrudable coatings for almost 20 years, but mainstream use of alginate casings, particularly in the fresh sausage or “hot dog” industry is still to be achieved, as the development of these casings is plagued with problems.

An optimal casing should preferably:
be edible,
be suitable for use with meat, vegetarian, vegan, Kosher and Halaal products,
comprise a suitable viscosity to ensure that it is capable of efficient co-extrusion with the sausage filling or batter,
be strong enough to ensure that the sausage filling or batter is held together during the cooking phase until the network sets to a solid matrix,
serve as a barrier between the sausage product and cooking fluid to avoid washing out of sausage filling or batter and therefore have low water permeability,
interact closely with the sausage filling or batter product to provide good adhesion to the surface of the filling or batter to prevent the casing from detaching from the sausage filling or batter during cooking,
be easy to tear or bite into, retaining the “bite factor” of traditional fresh, skinless meat products, and
be inconspicuous so as to provide a direct replacement for traditional fresh, skinless meat products.

Viscosity of the casing composition is the most critical component. It is essential that there is optimum rheology (gel flow properties) of the coating composition so that the food product can be coated properly during coextrusion without the casing flowing off the food product. At the same time, the viscosity of the composition cannot be too high, or it could cause blocking or sticking within the coating apparatus and a coating that is too dense and/or tough and unappealing to eat. In short, the properties of the coating composition required for optimal coating need to be balanced with the characteristics of the food product, in particular a fresh sausage product, for successful commercial use in a wide range of applications including boiling, pan-frying or fire grilling. In particular, viscosity must be balanced with the mechanical strength of the casing, density and thickness of the casing, optimal adhesion of the casing to the contained food product, the mouth feel and bite of the casing on the food product and the flavour of the coated food product.

There are many well known viscosity modifying agents used to obtain the optimum viscosity, including hydrocolloids, insoluble fibers, liquid smoke and plasticizers. However, these agents are expensive and each of these will exert additional effects on the casing material, that need to be managed for an ultimately commercially successful casing. For example, the use of liquid smoke imparts a flavour to the food product, which may not be desirable in a fresh sausage product, and may shorten the texture of the casing material. Hydrocolloids can result in an unpleasant oily feel to the casing. The composition of viscosity modifying agents also tends to vary slightly from batch to batch, requiring constant fine tuning of the coating material composition to ensure that target viscosities and properties are achieved. It would be advantageous if a simple coating composition for a food product, in particular a fresh sausage, mimicking a skinless-type sausage, whether filled with a meat, fish, vegetarian or vegan filling, could be developed with fewer ingredients and hence fewer variables, resulting in optimal reproducibility and consistency of use, and greater cost efficiency.

Early commercial alginate casing compositions comprised water, alginate, one or more acidifiers and starch/cellulose at a pH of 4 to 4.5. However, the casing on such products was tough and dense due to the alginate in these compositions reacting with Ca²⁺ ions at this pH to form a hydrogel.

More recently, WO 2014/007630 discloses modification of the pH of alginate casings to improve adhesion of the alginate composition to the food product by use of an acidic buffer solution at from between pH 3 to 6. The acidic buffer solution is contacted with the alginate composition immediately before, or during, extrusion to prevent ionic strength differences between the food particles and the alginate composition and to increase the hydrogen bonding between the alginate composition and the proteins present in the food particles. However, such a composition has not been successfully used in fine emulsion-type fresh sausages, such as fresh sausages, apparently because insufficient hydrogen bonding occurs with the proteins in such an emulsion.

It has been more recently demonstrated in WO 2017/191312 that by adjusting the pH of an alginate gel to between 3.3 and 3.9 thereby increasing the viscosity of the gel, followed by homogenising the alginate gel, a skinless sausage-type feel is obtained. The pH is critical, in that if the pH level is below this range, it will lead to the formation of insoluble crystalline regions in the alginate casing composition, whilst pH levels above this range will cause complete dissolution of the alginate in water. However, this methodology increases the complexity of the apparatus required to be used for co-extrusion, in that the apparatus must include a tank in which the pH optimised gel is first prepared, an in-line homogeniser, and then the coating apparatus to produce the coated sausage. In addition, the alginate gel must be held most preferably for more than 12 hours for the viscosity of the composition to reach a steady state, significantly adding to the duration of the process. The viscosity of this coating composition for effective functioning is required to be from 25 to 40 Pa·s, preferably from 28 to 37 Pa·s, and more preferably from 30 to 35 Pa·s at 5° C.

It would be useful if a food product with a skinless sausage-type feel could be obtained with a simpler and faster and hence more cost effective method of production.

### SUMMARY OF THE INVENTION

According to a first aspect of the invention there is provided an alginate composition for coating food products comprising or consisting of the following ingredients as a mixture:
(i) an alginate salt;
(ii) one or more organic or inorganic food-safe acidulants, including citric, malic, tartaric, lactic, acetic or ascorbic acid; and
(iii) water,
wherein the alginate composition has a pH of between about 4.0 to 4.2, preferably 4.05 to 4.10, and a shear viscosity of between about 25 to 65 Pa·s, more preferably between about 45 to 65 Pa·s measured at 4° C.

In an alternative embodiment of the invention the alginate composition comprises or consists of the following ingredients as a mixture:
a) an alginate salt;
b) one or more organic or inorganic food-safe acidulants, including citric, malic, tartaric, lactic, acetic or ascorbic acid;
c) water;
d) one or more hydrocolloidal galactomannan vegetable gums, including guar gum, tara gum, fenugreek gum, locust bean gum or cassia bean gum, more preferably guar gum, tara gum or fenugreek gum, even more preferably guar gum or tara gum, most preferably guar gum; and
e) one or more preservatives including a synthetic or natural preservative, in particular sodium benzoate,
wherein the alginate composition has a pH of between about 4.0 to 4.2, preferably 4.05 to 4.10, and a shear viscosity of between about 25 to 65 Pa·s, more preferably between about 45 to 65 Pa·s measured at 4° C.

Shear viscosity is determined using a Brookfield R/S plus rheometer having a Brookfield 25 mm cone spindle with a 1 degree plate angle (model 50.3.250 02 C25-1, 327).

In particular, the alginate composition may comprise or consist of the following ingredients:
a) about 4.5% to about 7.0% (w/w) sodium alginate, preferably about 5.0% to about 6.0% (w/w) sodium alginate;
b) about 0.38% to about 0.50% (w/w) acidulant, preferably citric acid;
c) optionally about 0.25% (w/w) hydrocolloidal galactomannan vegetable gum, preferably guar gum or tara gum;
d) optionally about 0.10% (w/w) preservative, preferably sodium benzoate; and
e) water.

In a preferred embodiment of the invention, the alginate composition comprises or consists of the following ingredients:
A. about 5.0% to about 6.0% (w/w) sodium alginate;
B. about 0.38% to about 0.50% (w/w) citric acid;
C. optionally about 0.25% (w/w) guar gum;
D. optionally about 0.10% (w/w) sodium benzoate; and
E. water.

The sodium alginate may comprise a ratio of between 50 to 66 α-L-guluronate (G): between 50 to 34 (1-4)-linked β-D-mannuronate (M), preferably 66 α-L-guluronate (G):34 (1-4)-linked β-D-mannuronate (M).

The composition may further optionally comprise plasticisers, vegetable oils, surfactants, colourants, flavourants, anti-microbial agents and other suitable additives known to those skilled in the art, but these compounds and compositions are not essential for the composition to be functional.

According to a further embodiment of the invention there is provided a method for preparing the alginate composition of the invention comprising or consisting of the following steps:
(i) blending or dissolving the acidulant in the water;
(ii) adding the remaining dry ingredients and blending by means of a mixer to form a paste; and
(iii) vacuum blending the paste to remove air.

The mixer may be a high-shear mixer or a low shear mixer having a mixer motor or simple mixer blade such as a Kenwood® mixer.

Optionally, the vacuum blending step may occur simultaneously with the blending.

According to a further embodiment of the invention there is provided a process for producing coated food products with the use of the alginate composition of the invention, the method comprising or consisting of the following steps:
(i) co-extruding a food product to be coated and the mixed alginate composition of the invention in a co-extruder apparatus to form an alginate composition coated food product;
(ii) applying a setting solution selected from the group consisting of: an acidulant, including lactic or citric acid; a calcium chloride solution or a hydrated form thereof including CaCl₂·2H₂O; and a calcium acetate solution to the coated food product to produce a gelled food product; and
(iii) optionally cutting the gelled food product to the desired dimensions.

The setting solution may be between about 3.0% to about 40.0%, or between about 3.0% to about 30.0%, or between about 5.5% to about 20.5% (w/w), or between about 15 to about 25%, or may be about 20% of the calcium chloride solution. Alternatively, the setting solution may be between about 3.0 to about 27.0% (w/w) of the calcium acetate solution.

The co-extrusion speed for between about 20 to 150 portions per minute (PPM) with a setting solution of between about 15 to 25%, preferably 20% calcium chloride for an approximately 100 mm length food product is typically between about 0.03 m/s to 0.25 m/s, whereas the co-extrusion speed for between about 50 to 100 PPM with a setting solution of between about 15 to 25%, preferably 20% calcium chloride for an approximately 100 mm length food product is typically between about 0.08 m/s to 0.17 m/s. The co-extrusion speed for between about 20 to 150 PPM with a setting solution of between about 15 to 25%, preferably 20% calcium chloride for an approximately 200 mm length food product is typically between about 0.06 m/s to 0.50 m/s.

The gelled food product may have a diameter of from between about 10 mm to about 32 mm, or between about 26 mm to about 30 mm.

The alginate coating composition may be extruded over the food product (e.g. through a die) at a thickness of between about 150 μm to about 400 μm. For example, where the food product is braaiwors or boerewors, the alginate coating composition may be extruded over the braaiwors or boerewors at a thickness of between about 200 μm to about 300 μm, or between about 250 μm to about 300 μm.

Co-extrusion may be performed with the use of the FreddyPro™ 1.0 or 2.0 apparatus described in more detail in South African patent numbers 2016/07790 and 2018/01072 incorporated herein by reference.

A cooker apparatus may optionally be included in the process if desired and may comprise addition of calcium in the form of a calcium chloride or calcium acetate solution in the cooker either with or without an acidulant such as citric acid. Furthermore an additional calcium drench step may be included if desired. However, neither of these additional apparatus or steps are essential for producing coated food products with the use of the alginate composition of the invention.

The food product of the invention may be a meat, fish, vegetarian or vegan food product. Preferably, the food product is a sausage. More preferably, the sausage is a fresh, skinless sausage. The food product may be a raw, partially cooked or cooked food product. Preferably, the food product is a raw food product.

In the case where the food product has added phosphates including sodium tripolyphosphate (Na₅P₃O₁₀), twice the mass quantity of food product of a calcium salt may be added to the food product, typically calcium lactate at about 0.3 to 0.6% (w/w). It is to be appreciated that other calcium salts such as calcium chloride or calcium lactate gluconate may be used, and these calcium salt equivalents would be calculated relative to the 0.3 to 0.6% of calcium lactate and added accordingly.

Once the coated food product has been prepared, it may be packaged. In some embodiments, the coated food product will be packaged as a single article, for example as a spiral of sausage in a package, similar to the traditional packaging method of South African braaiwors or boerewors. Alternatively, at least two, preferably at least four, and more preferably at least six coated food products will be included in a package.

According to a further embodiment of the invention there is provided a food product coated with the alginate composition of the invention. In particular, the food product may be a meat, fish, vegetarian or vegan food product. Preferably, the food product is a sausage. More preferably, the sausage is a fresh, skinless sausage.

Fresh, skinless meat sausages are particularly preferred and are intended to mimic the sensory attributes of fresh traditionally prepared sausages such as braaiwors or boerewors, pork, lamb, mutton, duck, turkey or chicken sausages, siskonmakkara, and breakfast sausages or bangers.

According to a further aspect of the invention there is provided a kit for producing an alginate composition for coating food products comprising or consisting of:
A. the following ingredients as a dry mixture:
   (i) an alginate salt;
   (ii) one or more organic or inorganic food-safe acidulants, including citric, malic, or tartaric acid, preferably citric acid; and
B. instructions for preparing a coating composition and/or a coated food product with addition of water using the methods described herein.

In an alternative embodiment of the invention the alternative embodiment the kit for producing an alginate composition for coating food products comprises or consists of:
A. the following ingredients as a dry mixture:
   (i) an alginate salt;
   (ii) one or more organic or inorganic food-safe acidulants, including citric, malic, or tartaric acid, preferably citric acid;
   (iii) one or more hydrocolloidal galactomannan vegetable gums, including guar gum, tara gum, fenugreek gum, locust bean gum or cassia bean gum, more preferably guar gum, tara gum or fenugreek gum, even more preferably guar gum or tara gum, most preferably guar gum;
   (iv) one or more preservatives including a synthetic or natural preservative, in particular sodium benzoate; and
B. instructions for preparing a coating composition and/or a coated food product with addition of water using the methods described herein.

In a further alternative embodiment, the kit for producing an alginate composition for coating food products may comprise or consist of:
A. the following ingredients as a dry mixture:
   (i) an alginate salt;
   (ii) optionally one or more hydrocolloidal galactomannan vegetable gums, including guar gum, tara gum, fenugreek gum, locust bean gum or cassia bean gum, more preferably guar gum, tara gum or fenugreek gum, even more preferably guar gum or tara gum, most preferably guar gum;
   (iii) optionally one or more preservatives including a synthetic or natural preservative, in particular sodium benzoate; and
B. the following ingredients as a wet mixture:
   (i) one or more organic or inorganic food-safe acidulants, including citric, malic, or tartaric acid dissolved in water, or lactic, acetic or ascorbic acid solution mixed with water; and
C. instructions for preparing a coating composition and/or a coated food product using the methods described herein.

In particular, the dry mixture may comprise or consist of the following ingredients:
I. about 4.5% to about 7.0% (w/w) sodium alginate, preferably about 5.0% to about 6.0% (w/w) sodium alginate;
II. about 0.38% to about 0.50% (w/w) acidulant, including citric, malic, or tartaric acid, preferably citric acid;
III. optionally about 0.25% (w/w) hydrocolloidal galactomannan vegetable gum, preferably guar gum or tara gum; and
IV. optionally about 0.10% (w/w) preservative, preferably sodium benzoate.

In a preferred embodiment of the invention, the dry mixture comprises or consists of the following ingredients:
1) about 5.0% to about 6.0% (w/w) sodium alginate;
2) about 0.38% to about 0.50% (w/w) citric acid;
3) optionally about 0.25% (w/w) guar gum; and
4) optionally about 0.10% (w/w) sodium benzoate.

### DETAILED DESCRIPTION OF THE INVENTION

This invention relates to an alginate composition for coating food products, in particular fresh, skinless meat, fish, vegetarian or vegan sausages and a method for producing the alginate composition. Furthermore, the invention relates to a method for producing coated food products with the use of the alginate composition of the invention.

Alginates are well known in the food industry. They are anionic polysaccharides composed of two monomers that are covalently bonded as homopolymeric blocks of (1-4)-linked β-D-mannuronate (designated M) and its C-5 epimer α-L-guluronate (designated G) residues. The blocks may occur as three combinations within the alginate polymer chains; GGGG, MMMM and GMGM. Alginates are used as gelling agents in the food industry as they will form crosslinks when contacted with multivalent metal ions. Typically, in the food industry calcium is the predominant choice, although barium, aluminium, strontium, magnesium and the like would also work. In particular, the crosslinking occurs in the GGGG regions of the alginate polymer. Accordingly, the preferred alginate for use in the invention comprises a ratio of 66 α-L-guluronate:34 β-D-mannuronate, although it is also possible to use a 50 α-L-guluronate:50 β-D-mannuronate alginate polymer. Furthermore, the applicant has identified that about 5 to 6% (w/w) sodium alginate is optimal for use in the alginate composition of the invention.

A number of hydrocolloidal galactomannan vegetable gums are known to those in the industry. For example, guar gum, tara gum, fenugreek gum, locust bean gum, and cassia bean gum (with the last two being soluble and thus functional only when heated during casing preparation) have been used in the food industry. Fenugreek, guar and tara gum are cold soluble have been used as thickening agents and stabilizers in food applications. Tara gum is less viscous than guar gum in a solution of the same concentration, but is more viscous than a solution of locust bean gum.

It is to be noted that at lower extrusion speeds (<1.0 m/s for example) the addition of a hydrocolloidal galactomannan vegetable gum is not required for an acceptably effective casing to be formed on food products.

However, if desired to be used, guar gum is the preferred galactomannan for use in the invention. It is more soluble than locust bean gum and is a better stabilizer. It is not self-gelling, but can also be cross-linked with calcium, causing it to gel. The applicant has found that about 0.25% (w/w) of guar gum is optimal for use in the alginate composition of the invention if desired to be included.

It is further to be noted that although any synthetic or natural preservative, including sodium benzoate, may be included in the coating composition, it is also possible to exclude the use of any preservative, such as for example in a case where the production environment is sterile and the casing is used with 2 weeks.

The viscosity of the alginate composition is important for effective co-extrusion with the meat product batter. The applicant has found that a shear viscosity of between about 25 to 65 Pa·s, a yield stress range of between about 200 to 650 Pa·s at 4° C., and a film thickness strength range at 250 μm thickness of between about 350 to 700 g/cm² is optimal. Viscosity is measured in Pa·s using a Brookfield R/S-CPS+ Rheometer (cone and plate) which is operated with an external temperature control system at 5° C., with a C25-1 spindle utilizing a sample volume of 0.08 ml. The system settings are: CSR setting, with a shear time of 120 s but a measuring point at 60 s under linear point distribution with the shear rate parameter selected, with a start and end value set at 20 s−1, and a distribution measuring points number of 60. The measuring temperature is set to 4° C.

The alginate composition has a pH range of between about 4 and about 4.2, with an optimal range of between about pH 4.05 and 4.10.

The applicant has determined that the alginate composition can be simply produced by blending each of the dry ingredients into water by means of a mixer to form a paste, followed by, or simultaneously, vacuum blending to remove air.

Typical high-shear mixers that may be used are well known to those skilled in the art and may include a Inxopa High Shear Mixer ME4105, a Cowles sawtooth blade mixer, a Silverson inline high shear mixer or a Bowl Chopper mixer.

However, any mixer, including a low shear mixer, even a kitchen mixer such as a Kenwood®, KitchenAid®, Bosch®, De'Longi®, Smeg®, Magimix® or the like may be used.

For example, the vacuum blender may be a Ruhle vacuum tumbler, a Promarks vacuum tumbler, a ribbon vacuum blender, or a Cozzini vacuum blender. Other vacuum blenders known to those skilled in the art such as Philips®, Ninja®, Nutribullet®, Russell Hobbs®, Bosch®, Nuwave® and the like can be used.

An additional aspect of the invention pertains to a process for producing coated food products with the use of the alginate composition. The method first comprises a standard method of co-extrusion of a food product to be coated with the alginate composition of the invention in a co-extruder apparatus through a die at an optimal thickness of 250 μm at a linear speed of 0.03 to 0.50 m/s to form an alginate composition coated food product.

For example, extrusion systems or apparatus that may be used include the FreddyPro™ apparatus described in more detail in South African patent numbers 2016/07790 and 2018/01072 incorporated herein by reference, and Lily systems as well as optionally the Vemag and ConPro systems.

The food product may be a raw, partially cooked or cooked food product, but is preferably, a raw food product.

For example, the food product may comprise meat, such as red meat (e.g. beef, lamb, mutton, goat or bison), pork, or poultry (e.g. chicken, duck or turkey). It will be appreciated that the food product will generally comprise further ingredients, such as flavourings (synthetic or natural, e.g. herbs), seasonings, breadcrumbs, oats, etc.

The food product is preferably a moulded food product, in which the ingredients have been processed (e.g. by chopping, shredding or grinding the ingredients). Moulded food products include burgers, kebabs and sausages.

A typical example of a fresh, skinless meat sausage product comprises the following:
(i) about 35% (w/w) mechanically deboned meat;
(ii) about 38% (w/w) pork trimmings;
(iii) about 18% (w/w) water;
(iv) about 5% starch;
(v) about 1.8% nitrite curing salt;
(vi) about 0.4% calcium lactate;
(vii) about 0.2% phosphate; and
(viii) about 1.96% flavourant.

A typical example of a braaiwors, skinless meat sausage product comprises the following:
(i) about 42% (w/w) mechanically deboned meat;
(ii) about 15% (w/w) beef fat
(iii) about 25% (w/w) water;
(iv) about 3% starch;
(v) about 5% soy isolate
(vi) about 0.30% calcium lactate
(vii) about 0.15% phosphate; and
(viii) about 9.55% flavourant.

The simple alginate composition of the invention is produced with good reproducibility and batch-to-batch consistency and can be used to produce a coated fresh, skinless sausage with excellent adhesion between the casing and the filling enclosed, which does not peel or separate when the sausage is broken and does not detach when the sausage is cooked or warmed by the consumer. The product is near indistinguishable from a traditional fresh, skinless sausage product and after cooking has a similar feel and “bite” effect.

The invention will be described by way of the following examples which are not to be construed as limiting in any way the scope of the invention.

### Example 1

The alginate casing composition is prepared by blending the following dry ingredients and water to reach 100% (w/w) in a high-shear mixer (all ingredients are provided as w/w):

| | |
|---|---|
| 6.00% | Sodium Alginate |
| 0.50% | Citric Acid |
| 0.25% | Guar Gum |
| 0.10% | Sodium Benzoate. |

Use of a 4800 rpm bowlchopper with 6 blades hydrates the ingredients in about 8 minutes.

The paste is then vacuum blended to remove air by means of a vacuum blender such as the Ruhle vacuum tumbler MKR 220, a Cozzini vacuum blender or a 3000 RPM bowl cutter.

### Example 2

The alginate casing composition is prepared by blending 0.50% Citric Acid and water, followed by adding the following dry ingredients to reach 100% (w/w) in a high-shear mixer (all ingredients are provided as w/w):

| | |
|---|---|
| 6.00% | Sodium Alginate |
| 0.25% | Guar Gum |
| 0.10% | Sodium Benzoate. |

Use of a 4800 rpm bowlchopper with 6 blades hydrates the ingredients in about 8 minutes.

The paste is then vacuum blended to remove air by means of a vacuum blender such as the Ruhle vacuum tumbler MKR 220, a Cozzini vacuum blender or a 3000 RPM bowl cutter.

### Example 3

Sausage meat paste is prepared by mixing the following:
(i) about 35% (w/w) mechanically deboned meat;
(ii) about 38% (w/w) pork trimmings;
(iii) about 18% (w/w) water;
(iv) about 5% starch;
(v) about 1.8% nitrite curing salt;
(vi) about 0.4% calcium lactate;
(vii) about 0.2% phosphate; and
(viii) about 1.96% flavourant.

Alternatively, for a braaiwors product, sausage meat paste is prepared by mixing the following:
(i) about 42% (w/w) mechanically deboned meat;
(ii) about 15% (w/w) beef fat
(iii) about 25% (w/w) water;
(iv) about 3% starch;
(v) about 5% soy isolate
(vi) about 0.30% calcium lactate
(vii) about 0.15% phosphate; and
(viii) about 9.55% flavourant.

The meat paste is then co-extruded with the prepared alginate casing composition, and a setting solution comprising 20% (w/w) calcium chloride is applied to the outer surface for about 1 second to gel the alginate casing a using the FreddyPro 1.0 or 2.0 co-extrusion apparatus. The coated sausages are then separated into portions before being packaged.

### Example 4

The alginate casing composition is prepared by blending 0.50% (w/w) Citric Acid and water, followed by addition of Sodium Alginate to a final amount of 6.00% (w/w) in a mixer under sterile conditions.

Use of a 4800 rpm bowlchopper with 6 blades hydrates the ingredients in about 8 minutes.

The paste is then vacuum blended to remove air by means of a vacuum blender such as the Ruhle vacuum tumbler MKR 220, a Cozzini vacuum blender or a 3000 RPM bowl cutter.

Sausage meat paste is then co-extruded at an extrusion speed of <1.0 m/s under sterile conditions with the prepared alginate casing composition paste, and a setting solution comprising 20% (w/w) calcium chloride is applied to the outer surface for about 1 second to gel the alginate casing using the FreddyPro 1.0 or 2.0 co-extrusion apparatus. The coated sausages are then separated into portions before being packaged.

1. An alginate composition for coating food products comprising or consisting of the following ingredients as a mixture:
(i) an alginate salt;
(ii) one or more organic or inorganic food-safe acidulants, comprising citric, malic, tartaric, lactic, acetic or ascorbic acid;
(iii) water;
(iv) optionally one or more hydrocolloidal galactomannan vegetable gums, comprising guar gum, tara gum, fenugreek gum, locust bean gum or cassia bean gum; and
(v) optionally one or more synthetic or natural preservatives including sodium benzoate,
wherein the alginate composition has a pH of between about 4.0 to 4.2, or 4.05 to 4.10, and a shear viscosity of between about 25 to 65 Pa·s, or between about 45 to 65 Pa·s measured at 4° C.

2. An alginate composition of claim 1, comprising or consisting of:
(i) an alginate salt;
(ii) one or more organic or inorganic food-safe acidulants, comprising citric, malic, tartaric, lactic, acetic or ascorbic acid;
(iii) water;
(iv) one or more hydrocolloidal galactomannan vegetable gums, comprising guar gum, tara gum, fenugreek gum, locust bean gum or cassia bean gum; and
(v) one or more synthetic or natural preservatives including sodium benzoate,
wherein the alginate composition has a pH of between about 4.0 to 4.2, or 4.05 to 4.10, and a shear viscosity of between about 25 to 65 Pa·s, or between about 45 to 65 Pa·s measured at 4° C.

3. The alginate composition according to claim 1, which comprises or consists of the following ingredients:
a) about 4.5% to about 7.0% (w/w) sodium alginate;
b) about 0.38% to about 0.50% (w/w) acidulant;
c) optionally about 0.25% (w/w) hydrocolloidal galactomannan vegetable gum;
d) optionally about 0.10% (w/w) preservative; and
e) water.

4. The alginate composition according to claim 1, which comprises or consists of the following ingredients:
A. about 5.0% to about 6.0% (w/w) sodium alginate;
B. about 0.38% to about 0.50% (w/w) citric add;
C. optionally about 0.25% (w/w) guar gum;
D. optionally about 0.10% (w/w) sodium benzoate; and
E. water.

5. A method for preparing the alginate composition according to claim 1, comprising or consisting of the following steps:
(i) blending or dissolving the acidulant in the water;
(ii) adding the remaining dry ingredients and blending by means of a high-shear or low-shear mixer to form a paste; and
(iii) vacuum blending the paste to remove air.

6. The method according to claim 5, wherein the vacuum blending step (iii) is performed simultaneously with the blending step (ii).

7. A process for producing coated food products with the use of the alginate composition according to claim 1, the process comprising or consisting of the following steps:
(i) co-extruding a food product to be coated and the alginate composition in a co extruder apparatus to form an alginate composition coated food product;
(ii) applying a setting solution selected from the group consisting of: an acidulant including lactic or citric acid; a calcium chloride solution or a hydrated form thereof including CaCl₂·2H 0; and a calcium acetate solution, of between about 3.0% to about 40.0%, or between about 3.0% to about 30.0%, or between about 5.5% to about 20.5% (w/w) of the calcium chloride solution or between about 3.0 to about 27.0% (w/w) of the calcium acetate solution to the coated food product to produce a gelled food product; and
(iii) optionally cutting the gelled food product to the desired dimensions.

8. The process according to claim 7, wherein the co-extrusion speed for between about 20 to 150 portions per minute (PPM) with a setting solution of between about 15 to 25%, preferably 20% calcium chloride for an approximately 100 mm length food product is between about 0.03 m/s to 0.25 m/s; the co-extrusion speed for between about 50 to 100 PPM with a setting solution of between about 15 to 25%, preferably 20% calcium chloride for an approximately 100 mm length food product is between about 0.08 m/s to 0.17 m/s; and the co-extrusion speed for between about 20 to 150 PPM with a setting solution of between about 15 to 25%, preferably 20% calcium chloride for an approximately 200 mm length food product is between about 0.06 m/s to 0.50 m/s.

9. The process according to claim 8, wherein the gelled food product has a diameter of from between about 10 mm to about 32 mm, or between about 26 mm to about 30 mm.

10. The process according to claim 8, wherein the alginate coating composition is co-extruded over the food product at a thickness of between about 150 pm to about 400 pm.

11. The process according to claim 10, wherein when the food product is braaiwors or boerewors, the alginate coating composition is co-extruded over the braaiwors or boerewors at a thickness of between about 200 pm to about 300 pm, or between about 250 pm to about 300 pm.

12. The process according to claim 11, wherein the food product is a meat, fish, vegetarian or vegan food product.

13. The process according to claim 12, wherein the food product is a sausage, including a fresh, skinless sausage.

14. The process according to claim 13, wherein the food product is a raw, partially cooked or cooked food product.

15. A food product coated with the alginate composition of claim 1.

16. The food product according to claim 15, which is a meat, fish, vegetarian or vegan food product.

17. The food product according to claim 15, wherein the food product is a sausage including a fresh, skinless sausage comprising braaiwors or boerewors, pork, lamb, mutton, duck, turkey or chicken sausages, siskonmakkara, breakfast sausages or bangers.

18. A kit for producing an alginate composition for coating food products comprising or consisting of:
A. the following ingredients as a dry mixture:
(i) an alginate salt;
(ii) one or more organic or inorganic food-safe acidulants, comprising citric, malic, or tartaric acid;
(iii) optionally one or more hydrocolloidal galactomannan vegetable gums, comprising guar gum, tara gum, fenugreek gum, locust bean gum or cassia bean gum, more preferably guar gum, tara gum or fenugreek gum, even more preferably guar gum or tara gum, most preferably guar gum;
(iv) optionally a preservative including a synthetic or natural preservative, in particular sodium benzoate; and
B. instructions for preparing a coating composition and/or a coated food product with addition of water using the methods described herein.

19. A kit for producing an alginate composition for coating food products of claim 18 comprising or consisting of:
A. the following ingredients as a dry mixture:
(i) an alginate salt;
(ii) one or more organic or inorganic food-safe acidulants, comprising citric, malic, or tartaric add;
(iii) one or more hydrocolloidal galactomannan vegetable gums, comprising guar gum; tara gum, fenugreek gum; locust bean gum or cassia bean gum, more preferably guar gum; tara gum or fenugreek gum, even more preferably guar gum or tara gum;
(iv) a preservative including a synthetic or natural preservative, in particular sodium benzoate; and
B. instructions for preparing a coating composition and/or a coated food product with addition of water using the methods described herein.

20. A kit for producing an alginate composition for coating food products comprising or consisting of:
A. the following ingredient as a dry mixture:
(i) an alginate salt;
B. the following ingredients as a wet mixture:
(i) one or more organic or inorganic food-safe acidulants, including citric; malic; or tartaric acid dissolved in water, or lactic; acetic or ascorbic add solution mixed with water; and
C. instructions for preparing a coating composition and/or a coated food product using the methods described herein.

21. A kit for producing an alginate composition for coating food products comprising or consisting of:
A. the following ingredients as a dry mixture:
(i) an alginate salt;
(ii) one or more hydrocolloidal galactomannan vegetable gums, including guar gum, tara gum, fenugreek gum, locust bean gum or cassia bean gum, more preferably guar gum, tara gum or fenugreek gum, even more preferably guar gum or tara gum, most preferably guar gum;
(iii) one or more preservatives including a synthetic or natural preservative, in particular sodium benzoate; and
B. the following ingredients as a wet mixture:
(i) one or more organic or inorganic food-safe acidulants, including citric, malic, or tartaric acid dissolved in water, or lactic, acetic or ascorbic acid solution mixed with water; and
C. instructions for preparing a coating composition and/or a coated food product using the methods described herein.

22. A kit according to claim 18, comprising or consisting of the following ingredients per total volume:
I. about 4.5% to about 7.0% (w/w) sodium alginate;
II. about 0.38% to about 0.50% (w/w) acidulant or citric acid;
II. optionally about 0.25% (w/w) hydrocolloidal galactomannan vegetable gum or guar gum; and
IV. optionally about 0.10% (w/w) preservative or sodium benzoate.

23. (canceled)
